(19) United States
(12) Patent Application Publication
(10) Pub. No.: US 2026/0200361 A1
(43) Pub. Date: Jul. 16, 2026

(54) BATTERY POWER DISPENSING UNIT, SYSTEM, AND METHOD FOR INDICATING CHARGING CONDITIONS

(71) Applicant: Caterpillar Inc., Peoria, IL (US)

(72) Inventors: Vamsi Krishna Doddakula, Dunlap, IL (US); Syed Hamail Ali Shah, Peoria, IL (US)

(73) Assignee: Caterpillar Inc., Peoria, IL (US)

(21) Appl. No.: 19/023,677

(22) Filed: Jan. 16, 2025

(51) Int. Cl. B60L 53/62; B60L 53/16; B60L 53/53; B60L 53/66

(52) U.S. Cl. CPC B60L 53/62; B60L 53/16; B60L 53/53; B60L 53/66; B60L 2200/40

(57) ABSTRACT

A system for indicating a charging condition includes a battery power dispensing unit and at least one flexible elongated illumination device in communication with and detachably affixed to the battery power dispensing unit. The illumination device is configurable in different shapes and capable of displaying multiple colors. The battery power dispensing unit is configured to determine and indicate the charging condition by illuminating the illumination device in at least one color. The charging condition corresponds to a dispenser state of charge of the power source, a connection or disconnection of a battery electric machine with the charging port or cable, a machine state of charge of the battery electric machine, a commencement or discontinuation of charging of the battery electric machine, the machine state of charge being equal to or greater than a predefined machine state of charge, and/or an error in the charging of the battery electric machine.

### TECHNICAL FIELD

The present disclosure relates, in general, to battery powered units or machines. More particularly, the present disclosure relates to a battery power dispensing unit, a system, and a method for indicating charging conditions.

### BACKGROUND

An electrified worksite such as an underground electrified mine site may employ different battery charging devices at different locations to charge battery electric machines operating within the electrified worksite. Typically, a battery electric machine is configured to be physically connected to a battery charging device to charge the battery electric machine. At present, an operator of the battery electric machine may be unable to conveniently determine a battery charging status of the battery electric machine upon connection with the battery charging device due to different operating conditions such as, but not limited to, miniaturised visual indicators or display of the battery charging devices or the battery electric machines, or limited illumination within the electrified worksite or within an operator area of the battery electric machine. Further, in some instances, the battery charging devices may also be battery powered, and the operator may be unable to conveniently determine whether the battery charging devices are sufficiently charged and available for use.

U.S. Pat. No. 9,597,970, herein referred to as the “US '970 reference”, relates to an electric vehicle charging apparatus has a housing having a body, and a light guide assembly adapted to display a status of the electric vehicle charging apparatus as a halo. The light guide assembly generates and displays one or more colors, flashing lights, or combinations thereof on a light exit region having a tilted side facing surface. The US '970 reference requires a configuration of light guide assembly within the electric vehicle charging apparatus to display the status of the electric vehicle charging apparatus. However, it may be desirable to display the status using existing charging devices in a simple and improved manner.

### SUMMARY

In an aspect of the present disclosure, a battery power dispensing unit is disclosed. The battery power dispensing unit includes a body, at least one power source, at least one charging port or cable, a dispenser processor in communication with the at least one power source, and at least one illumination device detachably affixed to the body and in communication with the dispenser processor via a network. The at least one illumination device is flexible, elongated, configurable in a plurality of shapes, and capable of displaying a plurality of colors. The battery power dispensing unit also includes a dispenser memory for storing instructions that when executed by the dispenser processor, causes the dispenser processor to determine at least one charging condition. The at least one charging condition corresponds to a dispenser state of charge of the at least one power source, a connection of a battery electric machine to the at least one charging port or cable, a machine state of charge of the battery electric machine, a commencement of charging of the battery electric machine via the at least one charging port or cable, the machine state of charge being equal to or greater than a predefined machine state of charge, a discontinuation of the charging of the battery electric machine, a disconnection of the battery electric machine from the at least one charging port or cable, and/or an error in the charging of the battery electric machine. The dispenser processor is also configured to illuminate the at least one illumination device in at least one color of the plurality of colors. The at least one color corresponds to at least one determined charging condition.

In another aspect of the present disclosure, a system for indicating at least one charging condition is disclosed. The system includes a battery power dispensing unit and at least one illumination device in communication with and detachably affixed to or in physical proximity to the battery power dispensing unit. The at least one illumination device is flexible, elongated, configurable in a plurality of shapes and capable of displaying a plurality of colors. The battery power dispensing unit is configured to determine the at least one charging condition. The at least one charging condition includes a dispenser state of charge of the at least one power source, a connection of a battery electric machine to the at least one charging port or cable, a machine state of charge of the battery electric machine, a commencement of charging of the battery electric machine via the at least one charging port or cable, the machine state of charge being equal to or greater than a predefined machine state of charge, a discontinuation of the charging of the battery electric machine, a disconnection of the battery electric machine from the at least one charging port or cable, and/or an error in the charging of the battery electric machine. The battery power dispensing unit is also configured to illuminate the at least one illumination device in at least one color of the plurality of colors. The at least one color corresponds to the at least one charging condition.

In yet another aspect of the present disclosure, a method for indicating at least one charging condition via at least one illumination device is disclosed. The at least one illumination device is flexible, elongated, configurable in a plurality of shapes, and capable of displaying a plurality of colors. The method includes determining, via a battery power dispensing unit, at least one charging condition. The at least one charging condition corresponds to a dispenser state of charge of at least one dispense power source of the battery power dispensing unit, a connection of a battery electric machine to at least one charging port or cable of the battery power dispensing unit, a machine state of charge of the battery electric machine, a commencement of charging of the battery electric machine via the at least one charging port or cable, the machine state of charge being equal to or greater than a predefined machine state of charge, a discontinuation of the charging of the battery electric machine, a disconnection of the battery electric machine from the at least one charging port or cable, and/or an error in the charging of the battery electric machine. The method also includes illuminating the at least one illumination device in the at least one color. The at least one color corresponds to the at least one determined charging condition.

### BRIEF DESCRIPTION OF DRAWINGS

FIG. 1 is an exemplary illustration of an environment including a battery power dispensing unit, an illumination device in communication with the battery power dispensing unit, and a battery electric machine, in accordance with which various embodiments of the present disclosure may be implemented;

FIG. 2 is an exemplary illustration of different views of a dispenser processor of the battery power dispensing unit of FIG. 1, in accordance with the embodiments of the present disclosure;

FIG. 3 is an exemplary illustration of the illumination device(s) of FIG. 1, in accordance with the embodiments of the present disclosure;

FIG. 4 is an exemplary illustration of the illumination devices of FIG. 3 detachably affixed to the battery power dispensing unit of FIG. 1, in accordance with the embodiments of the present disclosure;

FIG. 5 is an exemplary illustration of different colors displayed by the illuminating device(s) of FIG. 3 based on different charging conditions, in accordance with the embodiments of the present disclosure;

FIG. 6 is an exemplary illustration of different colors displayed by the illuminating device(s) of FIG. 3 based on a charging condition corresponding to a machine state of charge, in accordance with the embodiments of the present disclosure;

FIG. 7 is an exemplary illustration of different colors displayed by the illuminating device(s) of FIG. 3 based on a charging condition corresponding to a dispenser state of charge, in accordance with the embodiments of the present disclosure; and

FIG. 8 is an exemplary method for indicating the different charging conditions, in accordance with the embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

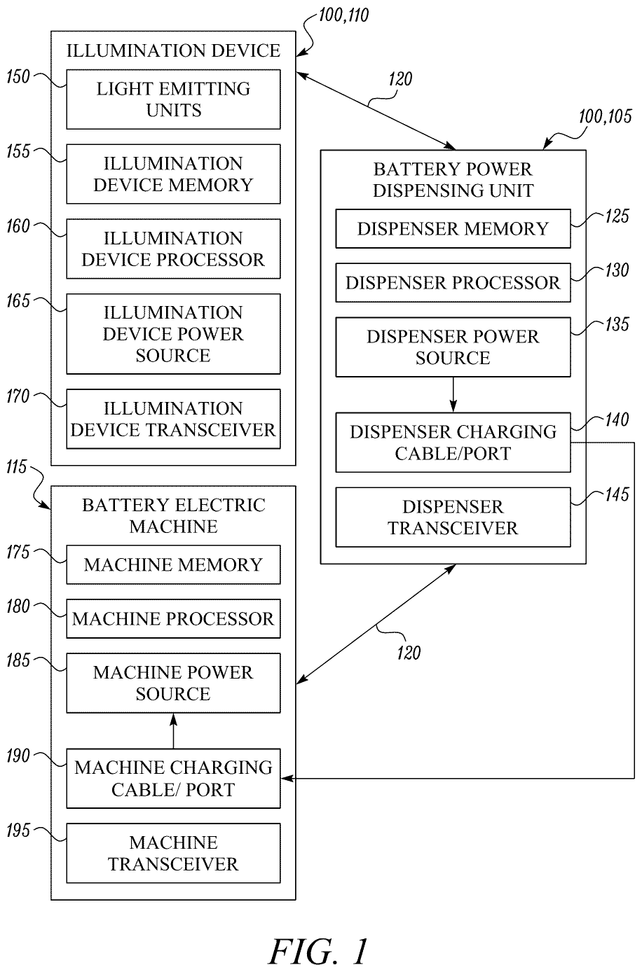

Referring to FIG. 1, an exemplary an environment including a battery power dispensing unit 105, an illumination device 110 in communication with the battery power dispensing unit 105, and a battery electric machine 115 is disclosed. In embodiments, the illumination device 110 and the battery electric machine 115 are in wired or wireless communication with the battery power dispensing unit 105 via a network 120. In embodiments, the illumination device 110 is flexible, elongated, configurable in a plurality of shapes, and capable of displaying a plurality of colors. In embodiments, the illumination device 110 corresponds to any light emitting device currently known or in future developed, including, but not limited to, devices with one or more Light Emitting Diodes (LEDs). Examples of the battery electric machine(s) 115 include, but are not limited to, haul trucks, water trucks, loaders, excavators, shovels, and tractors. Examples of the network 120 include, but are not limited to, a Controller Area Network (CAN), a Local Area Network (LAN), a Wireless Local Area Network (WLAN), a Small Area Network (SAN), a Wi-Fi Direct Network and a telecommunication network including, but not limited to, a fourth generation (4G) and a fifth generation (5G) cellular network. In embodiments, the battery power dispensing unit 105 is configured to supply electrical power or charge the battery electric machine 115 when the battery electric machine 115 is in wired or wireless connection or communication with the battery power dispensing unit 105. In embodiments, the battery power dispensing unit 105 corresponds to any power or energy storage device, currently known or in future developed, that is capable of being charged and/or capable of dispensing electrical power to a machine including, but not limited to, the battery electric machine 115 and/or a device including, but not limited to, the illumination device 110 in wired or wireless connection or communication with the battery power dispensing unit 105. In embodiments, the battery power dispensing unit 105 is configured to indicate at least one charging condition associated with the battery power dispensing unit 105 and/or the battery electric machine 115 via the illumination device 110. In embodiments, the battery power dispensing unit 105 is configured to illuminate the illumination device 110 in at least one color to indicate the at least one charging condition. In embodiments, the battery power dispensing unit 105 and the illumination device 110 may together define a system 100 for indicating the at least one charging condition.

It will be apparent to those with ordinary skill in the art that, in embodiments, multiple illumination devices like the illumination device 110 and multiple battery electric machines like the battery electric machine 115 may be connected to and/or in communication with the battery power dispensing unit 105 simultaneously or at different time periods. For example, a first battery electric machine (not shown) may be connected to the battery power dispensing unit 105 for a first time duration and a second battery electric machine may be connected to the battery power dispensing unit 105 for a second time duration. Similarly, in embodiments, both the first and second battery electric machines may be simultaneously connected to and charged via the battery power dispensing unit 105. In embodiments, the battery power dispensing unit 105 is configured to indicate at least one charging condition associated with multiple battery electric machines simultaneously. For example, the battery power dispensing unit 105 is configured to illuminate a first or a first set of illumination devices like the illumination device 110 in a first color to indicate a first charging condition of the first battery electric machine and illuminate a second or a second set of illumination devices like the illumination device 110 in a second color to indicate a second charging condition of the second battery electric machine. In embodiments, the battery power dispensing unit 105 is configured to illuminate a third or a third set of illumination devices like the illumination device 110 in a third color to indicate a third charging condition associated with the battery power dispensing unit 105.

In embodiments, the battery power dispensing unit 105 includes, among other components, a dispenser memory 125, dispenser processor 130, a dispenser power source 135, a dispenser charging port or cable 140, and dispenser transceiver 145. In embodiments, the dispenser power source 135 includes at least one battery capable of being charged or dispensing power when connected to a device, for example, the illumination device 110, or a machine, for example, the battery electric machine 115. In embodiments, the battery power dispensing unit 105 may also include one or more visual indicators to display data, text, video, images, audio, colors, and the like. Examples of the visual indicators include, but are not limited to, a dispenser display (not shown) and/or one or more light emitting devices currently known or in future developed. In embodiments, the dispenser display may include a display screen, or any other display means now known or in the future developed. In embodiments, the visual indicators may be configured to display or indicate the at least one charging condition, a illumination device identification associated with the illumination device 110, a status of the illumination device 110, a color displayed by the illumination device 110, and any other information related to the illumination device 110, and/or a machine identification, a type of machine, machine dimension(s), machine battery capacity, machine battery charge cycles, a machine state of charge, and any other information related to the battery electric machine 115 in a form of the data, the text, the images, the colors, and/or the audio.

In embodiments, the battery power dispensing unit 105 also includes one or more input devices (not shown) to receive one or more inputs. Examples of the input devices include, but not limited to, a keyboard, a touch screen display, a camera, a touch pad, a microphone, a recorder, a mouse or any other input device/mechanism now known or developed in the future. In embodiments, the battery power dispensing unit 105 also includes one or more output devices (not shown) including, but not limited to, the dispenser display, dispenser speakers, dispenser haptic output components, or any other output means, or mechanism now known or developed in the future. In embodiments, the output devices may be configured to display or indicate the at least one charging condition, the illumination device identification, the status of the illumination device 110, the color displayed by the illumination device 110, and any other information related to the illumination device 110, and/or the machine identification, the type of machine, the machine dimension(s), the machine battery capacity, the machine battery charge cycles, the machine state of charge, and any other information related to the battery electric machine 115 in the form of the data, the text, the images, the colors, and/or the audio.

Each component of the battery power dispensing unit 105 communicates with one another via a local interface (not shown). The local interface can be, such as, but not limited to, one or more buses or other wired or wireless connections, as is known in the art. The local interface can have additional elements, which are omitted for simplicity, such as controllers, buffers (caches), drivers, repeaters, and receivers, among many others, to enable communications. Further, the local interface can include address, control, and/or data connections to enable appropriate communications among the components of the battery power dispensing unit 105. In embodiments, the local interface includes a Controller Area Network (CAN) bus. The CAN bus is a communication system or protocol including, but not limited to, Society of Automotive Engineers standard SAE J1939 CAN protocol, that allows devices including, but not limited to, Electronic Control Units (ECUs), to communicate with each other. In embodiments, the ECUs are associated with the illumination device 110 and/or the battery electric machine 115. In embodiments, the battery power dispensing unit 105 may also include a dispenser gateway device (not shown) to convert CAN bus signals to wireless communication signals that implement wireless communication protocols including, but not limited to, Wi-Fi, Bluetooth ®, or other radio technologies now known or in future developed for wireless communication with different devices including, but not limited to, the illumination device 110 and/or the battery electric machine 115.

The dispenser transceiver 145 is configured provide one or more inputs to and receive one or more outputs from the illumination device 110 and/or the battery electric machine 115 when connected to or in communication with the battery power dispensing unit 105. The dispenser transceiver 145 includes a transmitter circuitry and a receiver circuitry to enable the battery power dispensing unit 105 to communicate data or instructions to and acquire data from the illumination device 110 and/or the battery electric machine 115 when connected to or in communication with the battery power dispensing unit 105. In this regard, the transmitter circuitry includes appropriate circuitry to provide the inputs via the network 120 to the illumination device 110 to illuminate the illumination device 110 in at least one color and provide a visual indication of the at least one charging condition associated with the battery power dispensing unit 105 or the battery electric machine 115. Similarly, the receiver circuitry includes appropriate circuitry to receive, via the network 120, the outputs including but not limited to, the machine identification, the type of machine, at least one machine dimension, the machine battery capacity, the machine battery charge cycles, the machine state of charge, and any other information related to the battery electric machine 115 from the battery electric machine 115 when connected to or in communication with the battery power dispensing unit 105. In embodiments, the receiver circuitry also includes appropriate circuitry to receive, via the network 120, the outputs including but not limited to, the illumination device identification, the status of the illumination device 110, the color displayed by the illumination device 110, and any other information related to the illumination device 110 from the illumination device 110 when connected to or in communication with the battery power dispensing unit 105. It will be appreciated by those of ordinary skill in the art that the battery power dispensing unit 105 can include a single dispenser transceiver like the dispenser transceiver 145, or alternatively separate transmitting and receiving components, for example but not limited to, a transmitter, a transmitting antenna, a receiver, and a receiving antenna.

The dispenser memory 125 is a non-transitory memory configured to store a set of instructions that are executable by the battery power dispensing unit 105 to perform predetermined operations. For example, the battery power dispensing unit 105 can include any of the volatile memory elements (for example, random access memory (RAM), nonvolatile memory elements (for example, read only memory (ROM), and combinations thereof. Moreover, the dispenser memory 125 can incorporate electronic, magnetic, optical, and/or other types of storage media. In some embodiments, the dispenser memory 125 is also configured to store files and/or information including, but not limited to, the illumination device identification, the status of the illumination device 110, the color displayed by the illumination device 110, and any other information related to the illumination device 110, and/or the machine identification, the type of machine, the machine dimension(s), the machine battery capacity, the machine battery charge cycles, the machine state of charge, and any other information related to the battery electric machine 115.

In embodiments, the dispenser processor 130 includes one or more microprocessors, microcontrollers, DSPs (digital signal processors), state machines, logic circuitry, or any other device or devices that process information or signals based on operational or programming instructions. In embodiments, the dispenser processor 130 is implemented using one or more controller technologies, such as Controller Area Network (CAN) technology, Application Specific Integrated Circuit (ASIC), Reduced Instruction Set Computing (RISC) technology, Complex Instruction Set Computing (CISC) technology, or any other similar technology now known or in the future developed. In embodiments, the dispenser processor 130 corresponds to a CAN controller. In embodiments, the dispenser processor 130 is configured to cooperate with other components of the battery power dispensing unit 105 to perform operations pursuant to communications and the one or more inputs received from the dispenser power source 135, the dispenser charging port or cable 140, the illumination device 110, and/or the battery electric machine 115. The dispenser processor 130 is configured to execute the instructions stored in the dispenser memory 125 to perform the predetermined operations, for example, illuminating the illumination device 110 in one or more colors to indicate the at least one charging condition in response to the inputs received from the dispenser power source 135, the dispenser charging port or cable 140, the illumination device 110, and/or the battery electric machine 115. In embodiments, the dispenser processor 130 is configured to determine a dispenser state of charge of the at least one dispenser power source 135, a connection of the battery electric machine 115 to the at least one dispenser charging port or cable 140, the machine state of charge of the battery electric machine 115, a commencement of charging of the battery electric machine 115 via the at least one dispenser charging port or cable 140, the machine state of charge being equal to or greater than a predefined machine state of charge, a discontinuation of the charging of the battery electric machine 115, a disconnection of the battery electric machine 115 from the at least one dispenser charging port or cable 140, and/or an error detected in the charging of the battery electric machine 115. In embodiments, the dispenser processor 130 is configured to monitor the machine state of charge to determine whether the machine state of charge being equal to or greater than the predefined machine state of charge. In embodiments, the dispenser processor 130 is configured to determine a rate of charging of the battery electric machine 115, a temperature of the at least one dispenser power source 135, or a machine power source 185, and a criticality or priority of the error detected. In embodiments, the dispenser processor 130 is configured to determine the detected error to be of low criticality or high criticality based on one or more charging parameters. Examples of the charging parameters include, but are not limited to, the determined temperature of the at least one dispenser power source 135 or a machine power source 185.

The dispenser processor 130 is configured to illuminate the illumination device 110 in the at least one color to indicate the at least one charging condition based on the determination. The at least one charging condition includes the dispenser state of charge of the at least one dispenser power source 135, the connection of the battery electric machine 115 to the at least one dispenser charging port or cable 140, the machine state of charge of the battery electric machine 115, the commencement of charging of the battery electric machine 115 via the at least one dispenser charging port or cable 140, the machine state of charge being equal to or greater than the predefined machine state of charge, the discontinuation of the charging of the battery electric machine 115, the disconnection of the battery electric machine 115 from the at least one dispenser charging port or cable 140, and/or the error in the charging of the battery electric machine 115. In embodiments, the dispenser processor 130 is configured to activate the illumination device 110 from a deactivated state. In embodiments, when the illumination device 110 is in the deactivated state and is in wired connection with the battery power dispensing unit 105, the battery power dispensing unit 105 may be configured to discontinue supply of the electric power to the illumination device and commence supply of the electric power to the illumination device 110 upon the activation of the illumination device 110. In embodiments, when the illumination device 110 is in the deactivated state and is in wireless connection with the battery power dispensing unit 105, illumination device 110 is configured to power off and power on using, for example, an illumination device power source 165, upon the activation of the illumination device 110 by the battery power dispensing unit 105.

In embodiments, the battery power dispensing unit 105 is configured to illuminate the illumination device 110 in a first color after the activation and prior to determining the at least one charging condition. In embodiments, each determined charging condition may be associated with a corresponding color. For example, the charging condition corresponding to the connection of the battery electric machine 115 to the at least one dispenser charging port or cable 140 may be associated with a second color. Similarly, the charging condition corresponding to the commencement the charging and the machine state of charge being equal to or greater than the predefined machine state of charge may be associated with a third color and a fourth color respectively. In embodiments, two or more charging conditions may be associated with a single color. For example, the charging condition corresponding to the disconnection or the discontinuation of the charging of the battery electric machine 115 may be associated with a fifth color. In embodiments, a single charging condition may be associated with two colors. For example, the charging condition corresponding to the error detected in the charging of the battery electric machine 115 may be associated with the two colors based on the criticality of the error determined by the dispenser processor 130. As an example, the charging condition with the detected error determined to be of low criticality may be associated with a sixth color and the charging condition with the detected error determined to be of high criticality may be associated with a seventh color.

In embodiments, the dispenser processor 130 is also configured to vary an intensity of the illumination of the color associated with one or more charging conditions. In embodiments, the dispenser processor 130 is configured to vary the intensity alternatively between a first intensity and a second intensity for a predefined period or until a change in the charging condition is determined by the dispenser processor 130. For example, the dispenser processor 130 is configured to vary the intensity of the illumination of the first color associated with the charging condition corresponding to the connection of the battery electric machine 115 to the dispenser charging port or cable 140 between the first intensity and the second intensity alternatively to indicate the connection until the commencement of the charging of the battery electric machine 115. In embodiments, the dispenser processor 130 is configured to vary a time duration between the alternative illumination based on at least one parameter associated with the at least one charging condition. The at least one parameter includes, but is not limited to, the determined rate of the charging of the battery electric machine 115 via the at least one dispenser charging port or cable 140, and the determined criticality or priority of the error in the charging. In embodiments, the time duration between the alternative illumination corresponding to a higher rate of charging is lesser than the time duration corresponding to a lower rate of charging in comparison. For example, the dispenser processor 130 is configured to illuminate the illumination device 110 in the third color between the first and second intensities alternatively for a shorter time duration for the charging condition corresponding to a higher rate of charging of the battery electric machine 115 in comparison with the charging condition corresponding to a lower rate of charging of the battery electric machine 115. As an example, the time duration between the first intensity and the second intensity may be equal to 0.5 seconds and 3 seconds for the higher charging rate and the lower charging rate respectively. Similarly, in embodiments, the time duration between the alternative illumination corresponding to the detected error determined to be of high criticality or priority is less than the time duration between the alternative illumination corresponding to the detected error determined to be of low criticality or priority. As an example, the time duration between the first intensity and the second intensity may be equal to 0.5 seconds and 3 seconds for the detected error determined to be high criticality and low criticality respectively.

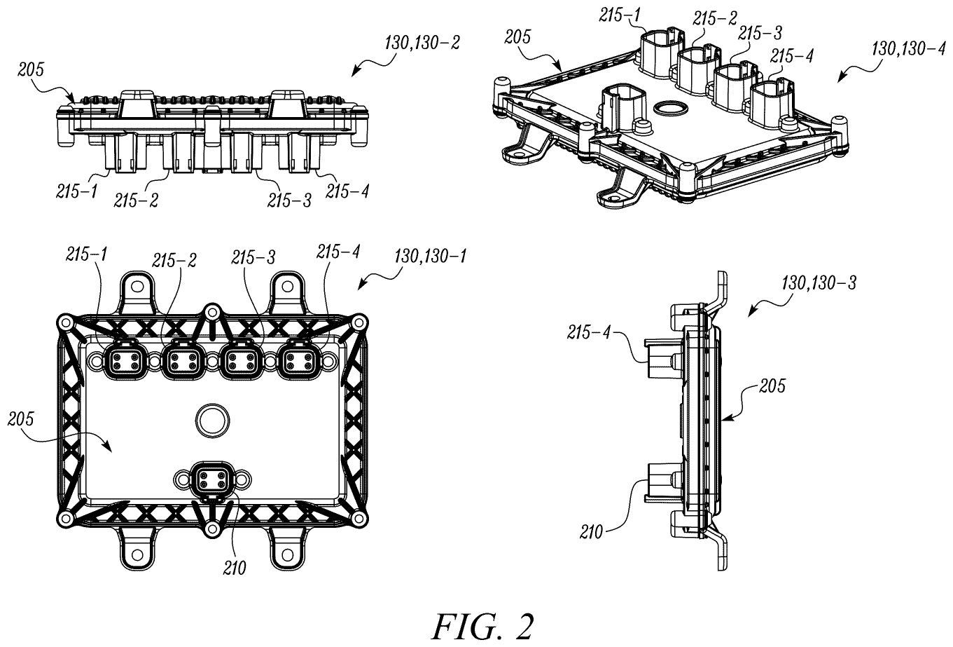

Referring to FIG. 2, an exemplary illustration of different views, for example, 130-1, 130-2, 130-3, 130-4, of the dispenser processor 130 corresponding to the CAN controller is disclosed. In embodiments, the dispenser processor 130 includes a controller casing 205, at least one input port, for example, 210, and at least one output port, for example, 215-1, 215-2, 215-3, 215-4. In embodiments, the input port, for example, 210 may be connected to the dispenser power source 135 and each output port of the output port(s), for example, 215-1, 215-2, 215-3, 215-4 may be connected to at least one illumination device 110. In embodiments, each output port, for example, 215-1, is associated with a predefined color and the dispenser processor 130 is configured to illuminate the illumination device 110 in the predefined color via the output port associated with the predefined color. For example, the output ports, for example, 215-1, 215-2, 215-3, 215-4 may be associated with the colors white, green, blue, and red respectively, and the dispenser processor 130 is configured to illuminate the illumination device 110 in the colors green, blue, yellow, and/or red via the output ports 215-1, 215-2, 215-3, 215-4 respectively.

Referring again to FIG. 1, in wired embodiments, for example when the illumination device 110 is in wired connection with the battery power dispensing unit 105 via the output ports, for example, 215-1, 215-2, 215-3, 215-4, the illumination device 110 may include only one or more light emitting units 150. In wired embodiments, the illumination device 110 may be simultaneously connected with the output ports, for example, 215-1, 215-2, 215-3, 215-4 via one or more wirings to display one or more colors associated with the output ports, for example, 215-1, 215-2, 215-3, 215-4 via the one or more light emitting units 150. In wired embodiments, the illumination device 110 may be simultaneously connected to one of the output ports, for example, 215-1 to display the predefined color associated with the output port 215-1 via the one or more light emitting units 150. In wireless embodiments, the illumination device 110 is in wireless communication with the battery power dispensing unit 105. In wireless embodiments, in addition to the one or more light emitting units 150, the illumination device 110 also includes an illumination device memory 155, an illumination device processor 160, an illumination device power source 165, and an illumination device transceiver 170. In wireless embodiments, when the illumination device 110 is powered on or activated via the battery power dispensing unit 105, the illumination device processor 160 is configured to receive the request for the activation and cause the illumination device power source 165 to supply electrical power to the light emitting units 150 to illuminate the light emitting units 150 and display one or more colors. In wireless embodiments, when the illumination device 110 is powered off, in the deactivated state, or deactivated via the battery power dispensing unit 105, the illumination device processor 160 is configured to receive the request for the deactivation and cause the illumination device power source 165 to discontinue the supply of the electrical power to the light emitting units 150. In wireless embodiments, each component of the illumination device 110 communicates with one another via an illumination device local interface (not shown). The illumination device local interface can be, such as, but not limited to, one or more buses or other wired or wireless connections, as is known in the art. The illumination device local interface can have additional elements, which are omitted for simplicity, such as controllers, buffers (caches), drivers, repeaters, and receivers, among many others, to enable communications. Further, the illumination device local interface can include address, control, and/or data connections to enable appropriate communications among the components of the illumination device 110. In wireless embodiments, the illumination device local interface includes the Controller Area Network (CAN) bus. In embodiments, the illumination device 110 may also include an illumination device gateway device (not shown) to convert CAN bus signals to wireless communication signals that implement wireless communication protocols for wireless communication with different devices including, but not limited to, the battery power dispensing unit 105 and/or the battery electric machine 115.

In wireless embodiments, the illumination device transceiver 170 is configured provide one or more inputs to and receive one or more outputs from the battery power dispensing unit 105. The illumination device transceiver 170 includes a transmitter circuitry and a receiver circuitry to enable the illumination device 110 to communicate data or instructions to and acquire data from the battery power dispensing unit 105. In this regard, the transmitter circuitry includes appropriate circuitry to provide the inputs including, but not limited to, the illumination device identification, the status of the illumination device 110, the color displayed by the illumination device 110, and any other information related to the illumination device 110 in a form of one or more signals, via, for example, the network 120, to the battery power dispensing unit 105. Similarly, the receiver circuitry includes appropriate circuitry to receive, via, for example, the network 120, the outputs including but not limited to, the at least one color to be displayed and/or an intensity of the at least one color to be displayed from the battery power dispensing unit 105. It will be appreciated by those of ordinary skill in the art that the illumination device 110 can include a single illumination device transceiver like the illumination device transceiver 170 as shown, or alternatively separate transmitting and receiving components, for example but not limited to, a transmitter, a transmitting antenna, a receiver, and a receiving antenna.

In wireless embodiments, the illumination device memory 155 is a non-transitory memory configured to store a set of instructions that are executable by the illumination device 110 to perform predetermined operations. For example, the illumination device 110 can include any of the volatile memory elements (for example, random access memory (RAM), nonvolatile memory elements (for example, read only memory (ROM), and combinations thereof. Moreover, the illumination device memory 155 can incorporate electronic, magnetic, optical, and/or other types of storage media. In wireless embodiments, the illumination device memory 155 is also configured to store files and/or information including, but not limited to, the illumination device identification, the status of the illumination device 110, the color displayed by the illumination device 110, and any other information related to the illumination device 110.

In wireless embodiments, the illumination device processor 160 includes one or more microprocessors, microcontrollers, DSPs (digital signal processors), state machines, logic circuitry, or any other device or devices that process information or signals based on operational or programming instructions. In embodiments, the illumination device processor 160 is implemented using one or more controller technologies, such as Controller Area Network (CAN) technology, Application Specific Integrated Circuit (ASIC), Reduced Instruction Set Computing (RISC) technology, Complex Instruction Set Computing (CISC) technology, or any other similar technology now known or in the future developed. In wireless embodiments, the illumination device processor 160 corresponds to a CAN controller. In wireless embodiments, the illumination device processor 160 is configured to cooperate with other components of the illumination device 110 to perform operations pursuant to communications and the one or more inputs received from the battery power dispensing unit 105. The illumination device processor 160 is configured to execute the instructions stored in the illumination device memory 155 to perform the predetermined operations, for example, illuminating the illumination device 110 in the at least color and in the intensity of the at least one color to indicate the at least one charging condition in response to the inputs received from the battery power dispensing unit 105. In both the wired and the wireless embodiments, the battery power dispensing unit 105 may include the illumination device 110 and together define the system 100 for indicating the at least one charging condition.

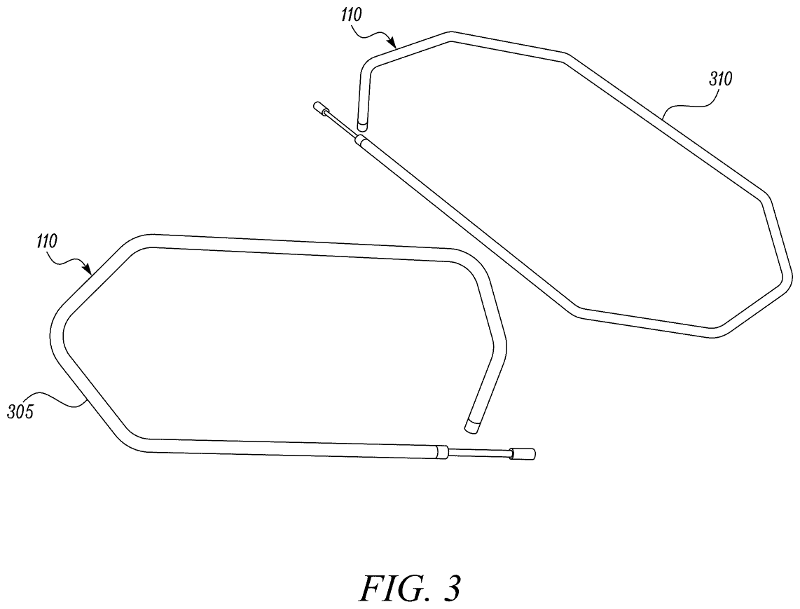

Referring to FIG. 3, an exemplary illustration of illumination devices, for example, 305, 310 like the illumination device 110 of FIG. 1 is disclosed. The illumination devices 305, 310 are flexible, elongated, configurable into different shapes, and capable of displaying a plurality of colors. The illumination devices 305, 310 are wireless devices configured to be in wireless communication with the battery power dispensing unit 105 via the network 120.

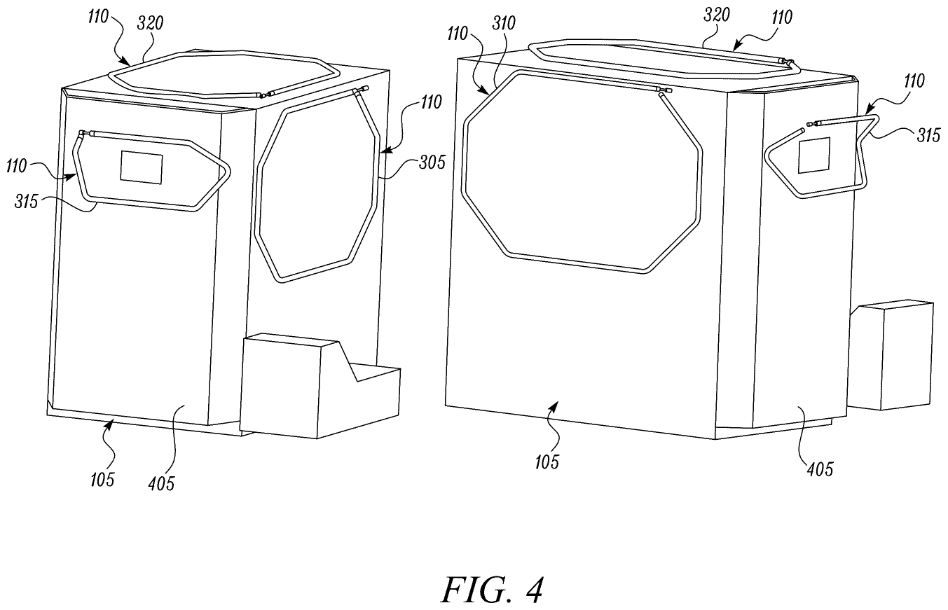

Referring for FIG. 4, an exemplary illustration of multiple illumination devices, for example, 305, 310, 315, 320 like the illumination device 110 of FIG. 1 detachable affixed to and in wireless communication with the battery power dispensing unit 105 is disclosed. In embodiments, the illumination devices, for example, 305, 310, 315, 320 may be affixed to different sides or portions of the battery power dispensing unit 105. For example, the battery power dispensing unit 105 in a shape of a cuboid may include at least four illumination devices, for example, 305, 310, 315, 320 affixed to at least four different sides or side surfaces of the battery power dispensing unit 105 in different shapes. In embodiments, the battery power dispensing unit 105 includes a body 405 and the illumination devices, for example, 305, 310, 315, 320 are affixed to the body 405. In embodiments, the body 405 may include a housing and the illumination devices, for example, 305, 310, 315, 320 may be provided on external surfaces or portions of the housing or in proximity to the housing. In embodiments, one or more components of the battery power dispensing unit 105, for example, 125, 130, 135, 145 (see FIG. 1) may be provided within the housing and one or more components, for example, the dispenser charging port or cable 140 (see FIG. 1) may be provided in the housing via one or more openings in the housing and/or may extend away from the one or more openings provided in the housing.

Referring again to FIG. 1, the battery electric machine 115 includes, among other components, a machine memory 175, a machine processor 180, a machine power source 185, a machine charging port or cable 190, and a machine transceiver 195. In embodiments, the machine power source 185 includes at least one battery capable of being charged or capable of dispensing power when connected to a device, for example, the battery power dispensing unit 105, or a machine. Each component of the battery electric machine 115 communicates with one another via a machine local interface (not shown). The machine local interface can be, such as, but not limited to, one or more buses or other wired or wireless connections, as is known in the art. The machine local interface can have additional elements, which are omitted for simplicity, such as controllers, buffers (caches), drivers, repeaters, and receivers, among many others, to enable communications. Further, the machine local interface can include address, control, and/or data connections to enable appropriate communications among the components of the battery power dispensing unit 105. In embodiments, the machine local interface includes a Controller Area Network (CAN) bus. In embodiments, the battery electric machine 115 may also include a machine gateway device (not shown) to convert CAN bus signals to wireless communication signals that implement wireless communication protocols for wireless communication with different devices including, but not limited to, the illumination device 110 and/or the battery power dispensing unit 105.

The machine transceiver 195 is configured provide one or more inputs to and receive one or more outputs from the battery power dispensing unit 105 wirelessly or upon connection of the machine charging port or cable 190 with the dispenser charging port or cable 140. The machine transceiver 195 includes a transmitter circuitry and a receiver circuitry to enable the battery electric machine 115 to communicate data or instructions to and acquire data from the battery power dispensing unit 105. In this regard, the transmitter circuitry includes appropriate circuitry to provide the inputs including, but not limited to, the machine identification, the type of machine, at least one machine dimension, the machine battery capacity, the machine battery charge cycles, the machine state of charge, and any other information related to the battery electric machine 115 in the form of one or more signals, via, for example, the network 120, to the battery power dispensing unit 105. Similarly, the receiver circuitry includes appropriate circuitry to receive, via, for example, the network 120, the outputs including, but not limited to, the at least one charging condition, the at least one color indicating the at least one charging condition, and any other information related to the at least one charging condition from the battery power dispensing unit 105. It will be appreciated by those of ordinary skill in the art that the battery electric machine 115 can include a single machine transceiver like the machine transceiver 195 as shown, or alternatively separate transmitting and receiving components, for example, but not limited to, a transmitter, a transmitting antenna, a receiver, and a receiving antenna.

The machine memory 175 is a non-transitory memory configured to store a set of instructions that are executable by the battery electric machine 115 to perform predetermined operations. For example, the battery electric machine 115 can include any of the volatile memory elements (for example, random access memory (RAM), nonvolatile memory elements (for example, read only memory (ROM), and combinations thereof. Moreover, the machine memory 175 can incorporate electronic, magnetic, optical, and/or other types of storage media. In some embodiments, the machine memory 175 is also configured to store files and/or information including, but not limited to, the machine identification, the type of machine, the machine dimension(s), the machine battery capacity, the machine battery charge cycles, the machine state of charge, and any other information related to the battery electric machine 115.

In embodiments, the machine processor 180 includes one or more microprocessors, microcontrollers, DSPs (digital signal processors), state machines, logic circuitry, or any other device or devices that process information or signals based on operational or programming instructions. In embodiments, the machine processor 180 is implemented using one or more controller technologies, such as Controller Area Network (CAN) technology, Application Specific Integrated Circuit (ASIC), Reduced Instruction Set Computing (RISC) technology, Complex Instruction Set Computing (CISC) technology, or any other similar technology now known or in the future developed. In embodiments, the machine processor 180 corresponds to a CAN controller. In embodiments, the machine processor 180 is configured to cooperate with other components of the battery electric machine 115 to perform operations pursuant to communications and the inputs received from the battery power dispensing unit 105. The machine processor 180 is configured to execute the instructions stored in the machine memory 175 to perform the predetermined operations, for example, providing the machine identification, the type of machine, the machine dimension(s), the machine battery capacity, the machine battery charge cycles, the machine state of charge, and any other information related to the battery electric machine 115 upon establishing the wireless communication with the battery power dispensing unit 105 or upon connection of the machine charging port or cable 190 with the dispenser charging port or cable 140.

In one embodiment, the battery power dispensing unit 105 is configured to detect a proximity of the battery electric machine 115 and initiate or establish the wireless communication with the battery electric machine 115. In another embodiment, the battery electric machine 115 is configured to detect a proximity of the battery power dispensing unit 105 and initiate or establish the wireless communication with the battery power dispensing unit 105. In yet another embodiment, the battery power dispensing unit 105 is configured to establish the wired communication with the battery electric machine 115 upon connection of the machine charging port or cable 190 of the battery electric machine 115 with the dispenser charging port or cable 140. In embodiments, the battery power dispensing unit 105 and the battery electric machine 115 can be in both wired and wireless communication simultaneously. In embodiments, the battery power dispensing unit 105 is configured to receive the machine identification, the type of machine, the machine dimension(s), the machine battery capacity, the machine battery charge cycles, the machine state of charge, and any other information related to the battery electric machine 115 from the battery electric machine 115 via the dispenser transceiver 145 upon the connection of the battery electric machine 115 to the battery power dispensing unit 105 via the dispenser charging port or cable 140 and/or upon establishing the wireless communication. In embodiments, the battery power dispensing unit 105 is configured to receive a first request via the battery electric machine 115 or the input devices (not shown) provided in the battery power dispensing unit 105 for charging the machine power source 185 provided in the battery electric machine 115 based on the established communication. In embodiments, the battery power dispensing unit 105 is configured to commence charging of the battery electric machine 115, via the dispenser power source 135, in response to the received first request. In embodiments, the battery power dispensing unit 105 is configured to receive a second request via the battery electric machine 115 or the input devices provided in the battery power dispensing unit 105 for discontinuing the charging of the battery electric machine 115. In embodiments, the battery power dispensing unit 105 is configured to discontinue the charging of the battery electric machine 115 in response to the received second request.

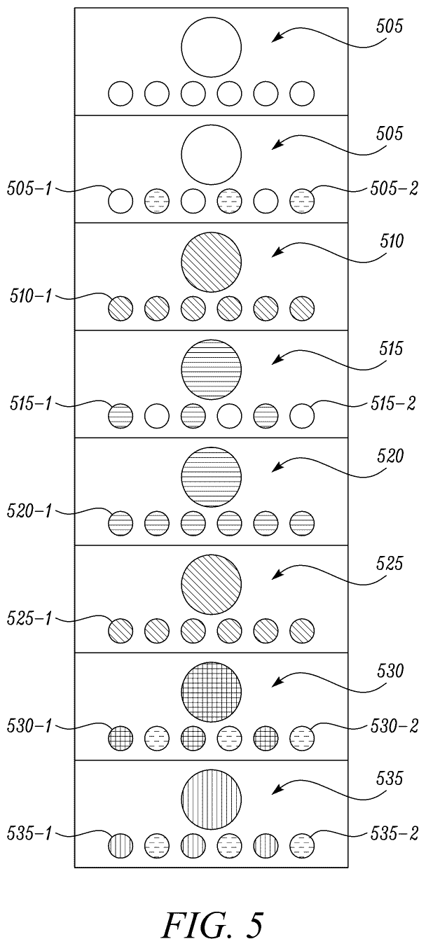

Referring to FIGS. 1 and 5, an exemplary illustration of different colors displayed by the illumination device 110 based on different charging conditions associated with the battery electric machine 115 determined by the battery power dispensing unit 105 is disclosed. In an exemplary embodiment, the battery power dispensing unit 105 is configured to activate and illuminate the illumination device 110 in a first color 505, for example, white color, until the wireless communication is established and vary the intensity of the first color 505 between the first intensity 505-1 and the second intensity 505-2 alternatively upon the establishment of the communication for a predefined time duration or until battery power dispensing unit 105 detects the change in the charging condition. For example, the battery power dispensing unit 105 is configured to detect the connection of the machine charging port or cable 190 of the battery electric machine 115 with the dispenser charging port or cable 140 and illuminate the illumination device 110 in a second color 510, for example, blue color, based on the detected connection prior to commencement of the charging of the battery electric machine 115. In embodiments, the battery power dispensing unit 105 is configured to maintain the illumination of the illumination device 110 in the second color 510 in the first intensity 510-1 until the change in the charging condition including, but not limited to, the commencement of charging of the battery electric machine 115 is detected. Similarly, the battery power dispensing unit 105 is configured to commence the charging of the battery electric machine 115 via the dispenser charging port or cable 140 and the machine charging port or cable 190 and simultaneously illuminate the illumination device 110 in a third color 515, for example, green color, upon the commencement of the charging. In embodiments, the battery power dispensing unit 105 is configured to vary the illumination corresponding to the third color 515 from the first intensity 515-1 to the second intensity 515-2 of the illumination alternatively and vary the time duration between the alternative illumination based on the rate of the charging of the battery power dispensing unit 105 until the machine state of charge is equal to the predefined machine state of charge. The battery power dispensing unit 105 is also configured to monitor the machine state of charge and determine whether the machine state of charge is equal to or greater than the predefined machine state of charge and illuminate the illumination device 110 in a fourth color 520 when the machine state of charge is equal to or greater than the predefined machine state of charge. In embodiments, the fourth color 520 is same as or different from the third color 515. In embodiments, the dispenser processor 130 is configured to maintain the first intensity 520-1 of the illumination of the illumination device 110 corresponding to the fourth color 520, for example, the green color that is the same as the third color 515, when the machine state of the charge of the battery electric machine 115 is equal to or greater than the predefined machine state of charge, or until the battery electric machine 115 is disconnected from the at least one dispenser charging port or cable 140 after the machine state of the charge of the battery electric vehicle is equal to the predefined machine state of charge, or until the discontinuation of the charging of the battery electric machine 115 by the battery power dispensing unit 105.

Further, the battery power dispensing unit 105 is also configured to detect the discontinuation of the charging of the battery electric machine 115 or detect the disconnection of machine charging port or cable 190 of the battery electric machine 115 from the dispenser charging port or cable 140 and illuminate the illumination device 110 in a fifth color 525 upon the detected disconnection or discontinuation of the charging of the battery electric machine 115. In embodiments, the second color 510 and the fifth color 525 may be the same or different. In embodiments, the battery power dispensing unit 105 is configured to maintain the illumination of the illumination device 110 in the fifth color 525, for example, the blue color that is the same as the second color 510, in the first intensity 525-1 until the battery electric machine 115 is re-connected to the battery power dispensing unit 105. In the exemplary embodiment, the battery power dispensing unit 105 is also configured to detect the error in the charging of the battery electric machine 115, determine the criticality or priority of the error, and illuminate the illumination device 110 in a sixth color 530, for example, yellow color, for the detected error determined to be of low criticality or a seventh color 535, for example, red color, for the detected error determined to be of high criticality. In embodiments, the battery power dispensing unit 105 is also configured to vary the intensity of the illumination of the sixth color between the first intensity 530-1 and the second intensity 530-2 alternatively for a first time duration between the alternative illumination. In embodiments, the battery power dispensing unit 105 is also configured to vary the intensity of the illumination of the seventh color between the first intensity 535-1 and the second intensity 535-2 alternatively for a second time duration between the alternative illumination. In embodiments, the first time duration and the second time duration are predefined corresponding to the detected error determined be of low criticality and the high criticality respectively. In the exemplary embodiment, the first color, second color, the third color, the fourth color, the fifth color, the sixth color, and the seventh color are indicative of the charging condition including, but not limited to, a battery charging status, associated with the battery electric machine 115. Further, it will be appreciated with those with ordinary skill in the art that one or more colors corresponding to one or more charging conditions associated with the battery electric machine 115 may be same or different.

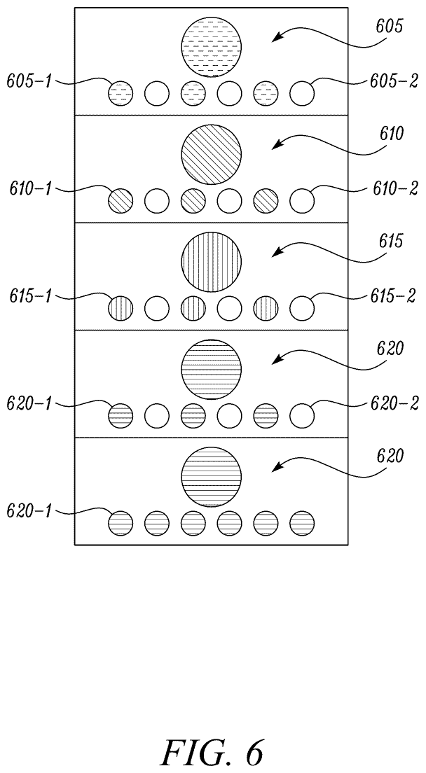

Referring to FIGS. 1 and 6, an exemplary illustration of different colors displayed by the illumination device 110 based on different charging conditions, including, but not limited to, the machine state of charge associated with the battery power dispensing unit 105 is disclosed. In embodiments, the battery power dispensing unit 105 is configured to monitor the machine state of charge of the machine power source 185 provided in the battery electric machine 115. In embodiments, the battery power dispensing unit 105 is also configured to illuminate the at least one illumination device 110 in the plurality of colors corresponding to a plurality of ranges of the monitored state of charge respectively. In embodiments, the battery power dispensing unit 105 is also configured to maintain a first intensity of the illumination corresponding to each color of the plurality of colors for each range of the plurality of ranges based on a decrease in the monitored state of charge. In embodiments, the decrease in the monitored state of charge corresponds to the discontinuation of charging or disconnection of the battery electric machine 115 from the battery power dispensing unit 105. In embodiments, the battery power dispensing unit 105 is also configured to vary an intensity of the illumination corresponding to each color for each range from the first intensity to a second intensity alternatively based on an increase in the monitored state of charge. In embodiments, the increase in the monitored state of charge corresponds to the charging of the battery electric machine 115 via the battery power dispensing unit 105. In embodiments, the battery power dispensing unit 105 is also configured to vary a time duration between the alternative illumination from the first intensity to the second intensity during the charging based on a rate of the increase in the monitored state of charge or the rate of the charging of the battery power dispensing unit 105.

For example, in an exemplary embodiment, the battery power dispensing unit 105 is configured to illuminate the illumination device 110 in a first color 605, for example, white color, corresponding to a first battery charge range ranging from zero to 20 percent of the machine state of charge, a second color 610, for example, yellow color, corresponding to a second battery charge range ranging from 20 to 40 percent of the machine state of charge, a third color 615, for example, blue color, corresponding to a third battery charge range ranging from 40 to 60 percent of the machine state of charge, and a fourth color 620, for example, green color, corresponding to a fourth battery charge range ranging from 60 to 80 percent of the machine state of charge during the charging of the battery electric machine 115. In embodiments, the battery power dispensing unit 105 is configured to vary the intensity of the illumination of the first color, the second color, the third color, and/or the fourth color between the first intensity and the second intensity, for example, 605-1, 605-2, 610-1, 610-2, 615-1, 615-2, and 620-1, 620-2 respectively during the charging. In embodiments, the battery power dispensing unit 105 is configured to vary the time duration between the alternative illumination based on the rate of the charging of the battery power dispensing unit 105. In embodiments, the battery power dispensing unit 105 is configured to maintain the fourth color 620 in the first intensity, for example, 620-1, in the illumination device 110 until the battery electric machine 115 is disconnected from the battery power dispensing unit 105 or the charging is discontinued by the battery power dispensing unit 105.

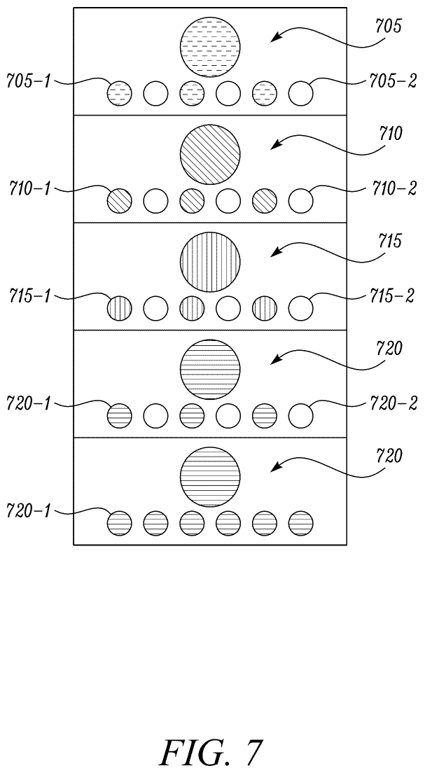

Referring to FIGS. 1 and 7, an exemplary illustration of different colors displayed by the illumination device 110 based on different charging conditions including, but not limited to, the dispenser state of charge associated with the battery power dispensing unit 105 is disclosed. In embodiments, the battery power dispensing unit 105 is configured to monitor the dispenser state of charge of the dispenser power source 135 of the battery power dispensing unit 105. In embodiments, the battery power dispensing unit 105 is configured to monitor the dispenser state of charge for instances when the battery power dispensing unit 105 is isolated from other connected electric devices including, but not limited to, the battery electric machine 115 and/or when a discharge of the electric power to the connected devices from the dispenser power source 135 is discontinued. In embodiments, the battery power dispensing unit 105 is also configured to illuminate the at least one illumination device 110 in the plurality of colors corresponding to a plurality of ranges of the monitored state of charge respectively. In embodiments, the battery power dispensing unit 105 is also configured to maintain a first intensity of the illumination corresponding to each color of the plurality of colors for each range of the plurality of ranges based on a decrease in the monitored state of charge. In embodiments, the battery power dispensing unit 105 is also configured to vary an intensity of the illumination corresponding to each color for each range from the first intensity to a second intensity alternatively based on an increase in the monitored state of charge. In embodiments, the battery power dispensing unit 105 is also configured to vary a time duration between the alternative illumination from the first intensity to the second intensity based on a rate of the increase in the monitored state of charge.

For example, in an exemplary embodiment, the battery power dispensing unit 105 is configured to illuminate the illumination device 110 in a first color 705, for example, white color, corresponding to a first battery charge range ranging from zero to 20 percent of the dispenser state of charge, a second color 710, for example, yellow color, corresponding to a second battery charge range ranging from 20 to 40 percent of the dispenser state of charge, a third color 715, for example, blue color, corresponding to a third battery charge range ranging from 40 to 60 percent of the dispenser state of charge, and a fourth color 720, for example, green color, corresponding to a fourth battery charge range ranging from 60 to 80 percent of the dispenser state of charge during the charging of the battery power dispensing unit 105. In embodiments, the battery power dispensing unit 105 is configured to vary the intensity of the illumination of the first color, the second color, the third color, and/or the fourth color in the illumination device 110 between the first intensity and the second intensity, for example, 705-1, 705-2, 710-1, 710-2, 715-1, 715-2, and 720-1, 720-2 respectively during the charging. In embodiments, the battery power dispensing unit 105 is configured to vary the time duration between the alternative illumination based on the rate of the charging of the battery power dispensing unit 105. In embodiments, the battery power dispensing unit 105 is configured to maintain the fourth color 720 in the first intensity, for example, 720-1, in the illumination device 110 until the battery electric machine 115 is disconnected from the battery power dispensing unit 105 or the charging is discontinued by the battery power dispensing unit 105.

It will be apparent to those with ordinary skill in the art that the battery power dispensing unit 105 may be configured to illuminate the illumination device 110 in different colors at different intensities of the illumination for each color and for different time durations between the intensities for each color based on the determined or detected charging condition, the rate of the charging of the battery power dispensing unit 105, and/or the criticality of the detected error in the charging.

### Industrial Applicability

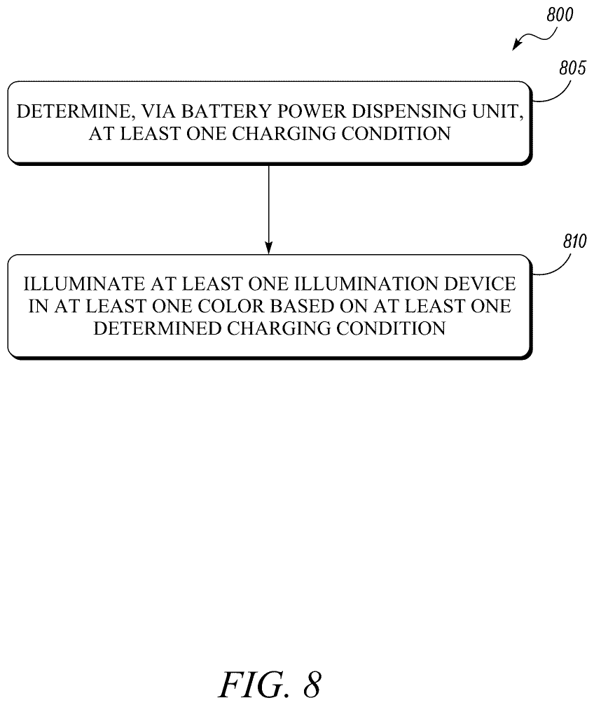

Referring to FIG. 8, an exemplary method 800 for indicating at least one charging condition via the battery power dispensing unit 105 of FIG. 1 and the illumination device 110 of FIGS. 1 and 3 is disclosed. The illumination device 110 is flexible, elongated, configurable in a plurality of shapes, and capable of displaying a plurality of colors. At step 805, the battery power dispensing unit 105 is configured to determine the at least one charging condition. The at least one charging condition includes a dispenser state of charge of the at least one dispenser power source 135 (see FIG. 1), a connection of a battery electric machine 115 (see FIG. 1) to the at least one dispenser charging port or cable 140 (see FIG. 1), a machine state of charge of the battery electric machine 115, a commencement of charging of the battery electric machine 115 via the at least one dispenser charging port or cable 140, the machine state of charge being equal to or greater than a predefined machine state of charge, a discontinuation of the charging of the battery electric machine 115, a disconnection of the battery electric machine 115 from the at least one dispenser charging port or cable 140, and/or an error in the charging of the battery electric machine 115. At step 810, the battery power dispensing unit 105 is configured to illuminate the at least one illumination device 110 in at least one color of the plurality of colors. The at least one color corresponds to the at least one determined charging condition. In embodiments, the illumination device 110 is configured to perform a step (not shown) of receiving at least one input including, but not limited to, a color to be displayed and an intensity of the color to be displayed, from the battery power dispensing unit 105. In embodiments, the battery power dispensing unit 105 is configured to perform a step (not shown) of varying the illumination corresponding to the at least one color from a first intensity to a second intensity alternatively based on the at least one charging condition. In embodiments, the battery power dispensing unit 105 is configured to perform a step (not shown) of varying a time duration between the alternative illumination based on at least one parameter associated with the at least one charging condition. The at least one parameter includes a rate of the charging of the battery electric machine 115 via the at least one dispenser charging port or cable 140 and/or a criticality of the error in the charging.

In embodiments, the battery power dispensing unit 105 is also configured to perform a step (not shown) of establishing communication with the battery electric machine 115 and illuminating the at least one illumination device 110 in a first color until and/or upon the establishment of the communication, a second color upon the connection of the battery electric machine 115 to the at least one dispenser charging port or cable 140 and prior to commencement of the charging of the battery electric machine 115, a third color upon the commencement of charging by the battery power dispensing unit 105, a fourth color when the machine state of charge is equal to or greater than the predefined machine state of charge, a fifth color upon the discontinuation of the charging of the battery electric machine 115, and a sixth color corresponding to the error in the charging of the battery electric machine 115. In embodiments, the first color, second color, the third color and the fourth color may be same or different and are indicative of a battery charging status of the battery electric machine 115.

In embodiments, the battery power dispensing unit 105 is also configured to perform a step (not shown) of monitoring the machine state of charge of a machine power source 185 (see FIG. 1) provided in the battery electric machine 115. In embodiments, the battery power dispensing unit 105 is also configured to perform a step (not shown) of illuminating the at least one illumination device 110 in the plurality of colors corresponding to a plurality of ranges of the monitored state of charge respectively. In embodiments, the battery power dispensing unit 105 is also configured to perform a step (not shown) of maintaining a first intensity of the illumination corresponding to each color of the plurality of colors for each range of the plurality of ranges based on a decrease in the monitored state of charge. In embodiments, the battery power dispensing unit 105 is also configured to perform a step (not shown) of varying an intensity of the illumination corresponding to each color for each range from the first intensity to a second intensity alternatively based on an increase in the monitored state of charge. In embodiments, the battery power dispensing unit 105 is also configured to perform a step (not shown) of varying a time duration between the alternative illumination from the first intensity to the second intensity based on a rate of the increase in the monitored state of charge.

It will be apparent that the system 100 including the battery power dispensing unit 105 and the illumination device 110 and the method 800 of the present disclosure enable an operator of the battery electric machine 115 to conveniently determine the charging condition(s) associated with the battery electric machine 115, including, but not limited to, the rate of the charging, the machine state of charge, connection or disconnection of the battery electric machine 115 with the battery power dispensing unit 105, and/or a commencement or discontinuation of the charging via the illuminated color when the battery electric machine 115 is connected or in communication with the battery power dispensing unit 105. The elongated and flexible configuration of the illumination device 110 also enables the illumination device 110 to be conveniently placed on and/or affixed to exterior portions of the battery power dispensing unit 105 at different locations on the battery power dispensing unit 105 and in different shapes depending on a configuration and/or a construction of the exterior portions of the battery power dispensing unit 105. In addition, by controlling the intensity of the illumination of the colors, the system 100 and the method 800 of the present disclosure ensure that the illuminated colors are visible up to at least 500 meters to an operator and may be particularly helpful in underground mine sites with limited visibility for the operators operating the battery electric machines, for example, 115. Further, by varying the time durations between the different intensities of the illumination displayed by the illumination device 110, the system 100 and the method 800 of the present disclosure conveniently help operators determine the rate of charging of the battery power dispensing unit 105. Furthermore, the system 100 and the method 800 of the present disclosure also enable the operators to conveniently determine the battery charging capacity of the battery power dispensing unit 105 and prioritize charging at different locations within a worksite, such as the mine site, prior to connecting or establishing communication with the battery power dispensing unit 105 based on the illuminated colors that may indicate the dispenser state of charge of the battery power dispensing unit 105. Similarly, in embodiments, the system 100 and the method 800 of the present disclosure also enable the operators to conveniently determine the machine state of charge based on the illuminated colors and allow the operators to make decisions on discontinuation of charging from and/or the connection with the battery power dispensing unit 105 based on production requirements and/or priority of tasks assigned to the battery electric machine 115.

Unless explicitly stated, the use of the singular to describe a component, structure, or operation does not exclude the use of plural such components, structures, or operations or their equivalents. The use of the terms “a” and “an” and “the” and “at least one” or the term “one or more,” and similar references herein are to be construed to cover both the singular and the plural, unless otherwise indicated herein. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; or A, B and B), unless otherwise indicated herein. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A battery power dispensing unit, comprising:
a body;
at least one power source;
at least one charging port or cable;
a dispenser processor in communication with the at least one power source and the at least one charging port or cable;
at least one illumination device detachably affixed to the body and in communication with the dispenser processor via a network, wherein the at least one illumination device is flexible, elongated, configurable in a plurality of shapes and capable of displaying a plurality of colors; and
a dispenser memory for storing instructions that when executed by the dispenser processor, causes the dispenser processor to:
determine at least one charging condition, wherein the at least one charging condition corresponds to a dispenser state of charge of the at least one power source, a connection of a battery electric machine to the at least one charging port or cable, a machine state of charge of the battery electric machine, a commencement of charging of the battery electric machine via the at least one charging port or cable, the machine state of charge being equal to or greater than a predefined machine state of charge, a discontinuation of the charging of the battery electric machine, a disconnection of the battery electric machine from the at least one charging port or cable, or an error in the charging of the battery electric machine; and
illuminate the at least one illumination device in at least one color of the plurality of colors, wherein the at least one color corresponds to the at least one determined charging condition.

2. The battery power dispensing unit of claim 1, wherein the dispenser processor is configured to:
vary the illumination corresponding to the at least one color from a first intensity to a second intensity alternatively based on the at least one determined charging condition.

3. The battery power dispensing unit of claim 2, wherein the dispenser processor is configured to:
vary a time duration between the alternative illumination based on at least one parameter associated with the at least one determined charging condition, the at least one parameter comprising a rate of the charging of the battery electric machine via the at least one charging port or cable or a criticality of the error in the charging.

4. The battery power dispensing unit of claim 1, wherein the dispenser processor is configured to:
establish communication with the battery electric machine; and
illuminate the at least one illumination device in a first color until or upon the establishment of the communication, a second color upon the connection of the battery electric machine to the at least one charging port or cable and prior to commencement of the charging of the battery electric machine, a third color upon the commencement of charging by the battery power dispensing unit, a fourth color when the machine state of charge is equal to or greater than the predefined machine state of charge, a fifth color upon the discontinuation of the charging of the battery electric machine, and a sixth color corresponding to the error in the charging of the battery electric machine, wherein the first color, second color, the third color and the fourth color are indicative of a battery charging status of the battery electric machine.

5. The battery power dispensing unit of claim 4, wherein the dispenser processor is configured to:
activate the at least one illumination device;
illuminate the at least one illumination device in the first color of the plurality of colors upon activation;
detect the connection or a proximity of the battery electric machine to the batter power dispensing unit, wherein the communication with the battery electric machine is established based on the detection or the proximity; and
vary an intensity of the illumination corresponding to the first color until the communication is established.

6. The battery power dispensing unit of claim 4, wherein the dispenser processor is configured to:
detect the connection of the battery electric machine to the battery power dispensing unit, wherein the at least one illumination device is illuminated in the second color upon the detection until the commencement of the charging after the request for charging is received.

7. The battery power dispensing unit of claim 4, wherein the dispenser processor is configured to:
receive a request via the battery electric machine or at least one input means provided in the battery power dispensing unit for charging at least one machine power source provided in the battery electric machine based on the established communication;
commence charging of the at least one machine power source based on the request, wherein the at least one illumination device is illuminated in the third color upon the commencement of charging; and
vary the illumination corresponding to the third color from a first intensity to a second intensity of the illumination alternatively and a time duration between the alternative illumination based on a rate of the charging of the battery power dispensing unit until the machine state of charge is equal to the predefined machine state of charge.

8. The battery power dispensing unit of claim 4, wherein the fourth color is same as or different from the third color, and the dispenser processor is configured to:
maintain a first intensity of the illumination of the at least one illumination device corresponding to the fourth color when the machine state of the charge of the battery electric vehicle is equal to or greater than the predefined machine state of charge or until the battery electric machine is disconnected from the at least charging port or cable after the machine state of the charge of the battery electric vehicle is equal to the predefined machine state of charge.

9. The battery power dispensing unit of claim 4, wherein the dispenser processor is configured to:
receive a request to discontinue the charging of at least one machine power source provided in the battery electric machine based on the established communication; and
discontinue the charging of the at least one machine power source based on the request, wherein the at least one illumination device is illuminated in the fifth color until the battery electric machine is connected to the battery power dispensing unit.

10. The battery power dispensing unit of claim 4, wherein the dispenser processor is configured to:
detect the error during the charging; and
determine a criticality of the detected error in the charging, wherein the at least one illumination device is illuminated in the sixth color or a seventh color to indicate the detected error based on the criticality of the detected error.

11. The battery power dispensing unit of claim 1, wherein the dispenser processor is configured to:
monitor the machine state of charge of at least one machine power source provided in the battery electric machine;
illuminate the at least one illumination device in the plurality of colors corresponding to a plurality of ranges of the monitored state of charge respectively; and
maintain a first intensity of the illumination corresponding to each color of the plurality of colors for each range of the plurality of ranges based on a decrease in the monitored state of charge; or
vary an intensity of the illumination corresponding to each color for each range from the first intensity to a second intensity alternatively based on an increase in the monitored state of charge; and
vary a time duration between the alternative illumination from the first intensity to the second intensity based on a rate of the increase in the monitored state of charge.

12. The battery power dispensing unit of claim 1, wherein the network is a controller area network (CAN).

13. The battery power dispensing unit of claim 1, wherein the at least one illumination device corresponds to a plurality of illumination devices provided on at least four mutually perpendicular surfaces of the body in at least two different shapes of the plurality of shapes.

14. The battery power dispensing unit of claim 1, wherein the at least one illumination device comprises an illumination device processor and at least one light emitting unit in communication with the illumination device processor, the illumination device processor configured to:
receive at least one input from the battery power dispensing unit, wherein the at least one input comprises the at least one color of the plurality of colors, an intensity of the illumination corresponding to the at least one color, or a combination of the at least one color and the intensity; and
illuminate the at least one light emitting unit in the at least one color and the intensity based in the at least one received input.

15. A system for indicating at least one charging condition, comprising:
a battery power dispensing unit;
at least one illumination device is communication with and detachably affixed to or in physical proximity to the battery power dispensing unit, wherein the at least one illumination device is flexible, elongated, configurable in a plurality of shapes, and capable of displaying a plurality of colors, and the battery power dispensing unit is configured to:
determine the at least one charging condition, wherein the at least one charging condition corresponds to a dispenser state of charge of the at least one power source, a connection of a battery electric machine to the at least one charging port or cable, a machine state of charge of the battery electric machine, a commencement of charging of the battery electric machine via the at least one charging port or cable, the machine state of charge being equal to or greater than a predefined machine state of charge, a discontinuation of the charging of the battery electric machine, a disconnection of the battery electric machine from the at least one charging port or cable, or an error in the charging of the battery electric machine; and
illuminate the at least one illumination device in at least one color of the plurality of colors, wherein the at least one color corresponds to the at least one determined charging condition.

16. A method for indicating at least one charging condition via at least one illumination device that is flexible, elongated, configurable in a plurality of shapes, and capable of displaying a plurality of colors, comprising:
determining, by a battery power dispensing unit, the at least one charging condition, wherein the at least one charging condition corresponds to a dispenser state of charge, a connection of the battery electric machine to the at least one charging port or cable of the battery power dispensing unit, a machine state of charge of the battery electric machine, the commencement of charging of the battery electric machine via the at least one charging port or cable, the machine state of charge determined to be equal to or greater than a predefined machine state of charge, a discontinuation of the charging of the battery electric machine, a disconnection of the battery electric machine from the at least one charging port or cable, or an error in the charging of the battery electric machine; and
illuminating, by the battery power dispensing unit, the at least one illumination device in at least one color of the plurality of colors, wherein the at least one color corresponds to the at least one determined charging condition.

17. The method of claim 16, comprising:
receiving, by the at least one illumination device, at least one input from the battery power dispensing unit, wherein the at least one input comprises information indicative of an illumination associated with the at least one color, an intensity of the illumination corresponding to the at least one color, or a combination of the at least one color and the intensity.

18. The method of claim 16, comprising:
varying, by the battery power dispensing unit, the illumination corresponding to the at least one color from a first intensity to a second intensity alternatively based on the at least one charging condition; and
varying, by the battery power dispensing unit, a time duration between the alternative illumination based on at least one parameter associated with the at least one charging condition, the at least one parameter comprising a rate of the charging of the battery electric machine via the at least one charging port or cable or a criticality of the error in the charging.

19. The method of claim 16, comprising:
establishing, by the battery power dispensing unit, a communication with the battery electric machine; and
illuminating, by the battery power dispensing unit, the at least one illumination device in a first color until or upon establishment of the communication, a second color upon the connection of the battery electric machine to the at least one charging port or cable and prior to commencement of the charging of the battery electric machine, a third color upon the commencement of the charging by the battery power dispensing unit, a fourth color when the machine state of charge is equal to or greater than the predefined machine state of charge, a fifth color upon the discontinuation of the charging of the battery electric machine, and a sixth color corresponding to the error in the charging of the battery electric machine, wherein the first color, second color, the third color and the fourth color are indicative of a battery charging status of the battery electric machine.

20. The method of claim 16, comprising:
monitoring, by the battery power dispensing unit, the machine state of charge of a machine power source provided in the battery electric machine;
illuminating, by the battery power dispensing unit, the at least one illumination device in the plurality of colors corresponding to a plurality of ranges of the monitored state of charge respectively; and
maintaining, by the battery power dispensing unit, a first intensity of the illumination corresponding to each color of the plurality of colors for each range of the plurality of ranges based on a decrease in the monitored state of charge; or
varying, by the battery power dispensing unit, an intensity of the illumination corresponding to each color for each range from the first intensity to a second intensity alternatively based on an increase in the monitored state of charge; and
varying, by the battery power dispensing unit, a time duration between the alternative illumination from the first intensity to the second intensity based on a rate of the increase in the monitored state of charge.
